(19) United States
(12) Patent Application Publication
(10) Pub. No.: US 2004/0250104 A1
(43) Pub. Date: Dec. 9, 2004

(54) Method of processing data and data processing apparatus

(76) Inventors: Yuji Handa, Ueda-shi (JP); Kazuki Takahashi, Ueda-shi (JP)

Correspondence Address: BIRCH STEWART KOLASCH & BIRCH, PO BOX 747, FALLS CHURCH, VA, 22040-0747, US

(21) Appl. No.: 10/824,352

(22) Filed: Apr. 15, 2004

(30) Foreign Application Priority Data
Apr. 22, 2003 (JP) 2003-117383

(51) Int. Cl. H04K 1/00

(52) U.S. Cl. 713/193

(57) ABSTRACT

By the method of processing data, the data can be processed, without encrypting and decrypting all of the data, so as to keep secrecy of the data. The method comprises the steps of: storing data of a system area of a recording medium, which are used by the writing means so as to recognize the recording medium; encrypting at least a part of the data of the system area on the basis of a password; storing main data; writing the encrypted data of the system area in the recording medium; and writing the main data in the recording medium.

### BACKGROUND OF THE INVENTION

The present invention relates to a method of processing data and a data processing apparatus.

Conventionally, data are encrypted, by encrypting programs, so as to keep secrecy of the data. Encrypting programs encrypt data on the basis of algorithms defined therein. To access to the encrypted data, a user inputs a password, which has been assigned, then the encrypted data are decrypted on the basis of a decrypting algorithm, which corresponds to an encrypting algorithm. The user can actually use the data after the data are decrypted.

Namely, data are encrypted and decrypted by application programs, but a data recording and reading apparatus, which is capable of encrypting and decrypting data, is disclosed in Japanese Patent Gazette No. 01-227272.

However, the Japanese Patent Gazette does not describe about a password, which is an important factor of data encryption. Determining a password by user and an encrypting process based on the password are not described. In the apparatus, ordinary data (data not encrypted) are merely encrypted on the basis of an algorithm stored in a data encrypting unit.

Anybody can easily decrypt the data, which are encrypted by the apparatus disclosed in the Japanese Patent Gazette, by the same apparatus, so that the secrecy of the data cannot be kept.

Further, encrypting ordinary data by encrypting programs and decrypting encrypted data by decrypting programs apply great loads to a CPU of a computer. Therefore, the computer cannot work smoothly while encrypting and decrypting data.

To solve the problems, the inventors of the present invention invented a data processing apparatus, which was filed as Japanese Patent Application No. 2003-014219. However, CPUs of many data processing apparatuses have low calculating powers, so it takes a long time to encrypt all of data. In some cases, time for encrypting data is longer than time for encrypting data by application program and writing encrypted data on a recording medium.

### SUMMARY OF THE INVENTION

An object of the present invention is to provide a method of processing data, in which the data can be processed, without encrypting and decrypting all of the data, so as to keep secrecy of the data.

Another object of the present invention is to provide a data processing apparatus performing said method.

To achieve the objects, the present invention has following structures.

Namely, the method of writing data with a data processing apparatus comprises:

means for storing data;

means for writing data in a recording medium; and

means for encrypting data on the basis of a password,

the method comprises the steps of:

storing data of a system area of the recording medium, which are used by the writing means so as to recognize the recording medium, in the storing means;

encrypting at least a part of the data of the system area, by the encrypting means, on the basis of the password;

storing main data in the storing means;

writing the encrypted data of the system area, by the writing means, in the recording medium; and

writing the main data, by the writing means, in the recording medium.

And, the data processing apparatus comprises:

means for storing data;

means for writing data in a recording medium;

means for encrypting data on the basis of a password; and

means for controlling the storing means, the writing means and the encrypting means,

wherein the control means stores data of a system area of the recording medium, which are used by the writing means so as to recognize the recording medium, in the storing means,

encrypts at least a part of the data of the system area, by the encrypting means, on the basis of the password,

stores main data in the storing means,

writes the encrypted data of the system area, by the writing means, in the recording medium, and

writes the main data, by the writing means, in the recording medium.

With the method and the apparatus, all of the data to be written need not be encrypted, so the data can be written at high speed, by a low power CPU, with proper security.

Preferably, in the data processing apparatus, an ancillary password is previously stored in the storing means, the control means adds the ancillary password to the password, and the encrypting means encrypts the data of the system area on the basis of the combined password. With this structure, attributes of the data of the system area can be defined when the data are decrypted. Further, secrecy of data can be further improved when the encrypted data are decrypted.

Preferably, the storing means selectively stores the password or a combined password which is constituted by the password and an ancillary password. With this structure, a user needs not to determine the password for each use. If the apparatus is used by limited users using a common password, only the limited users can decrypt the data. Secrecy of data can be kept within the limited users.

Note that, the ancillary password may be a datum of the apparatus. In this case, attributes of the data can be easily known. A plurality of the ancillary passwords may be stored in the storing means so as to further improve the secrecy of data.

Further, in the apparatus, the storing means may previously store hush function data, the control means may convert the password into a hush value on the basis of the hush function data, and the encrypting means may encrypt the data of the system area on the basis of the hush value. With this structure, variations of secrecy, which are caused by passwords determined by users, can be uniform. Further, length of encryption keys can be fixed, so processing the data can be easily performed.

Another method of reading data with a data processing apparatus comprises:

means for storing data;

means for reading data from a recording medium; and

means for decrypting encrypted data on the basis of a password, the method comprises the steps of:

accessing the reading means to data of a system area of the recording medium, which are used so as to recognize the recording medium;

storing the data of the system area, which have been encrypted, in the storing means; and

decrypting the encrypted data of the system area, by the decrypting means, on the basis of the password.

And, another data processing apparatus comprises:

means for storing data;

means for reading data from a recording medium;

means for decrypting encrypted data on the basis of a password; and

means for controlling the storing means, the reading means and the decrypting means,

wherein the control means accesses the reading means to data of a system area of the recording medium, which are used so as to recognize the recording medium;

stores the data of the system area, which have been encrypted, in the storing means; and

decrypts the encrypted data of the system area, by the decrypting means, on the basis of the password.

With this method and the apparatus, even if all of the data are not encrypted, the data of the system area can be read unless the correct password is inputted. Namely, even if all of the data are not encrypted, secrecy of the data can be kept as well as the case of encrypting all of the data.

Preferably, in the data processing apparatus, an ancillary password is previously stored in the storing means, the control means adds the ancillary password to the password, and the encrypting means encrypts the data of the system area on the basis of the combined password. With this structure, the encrypted data of the system area, which have attributes, can be decrypted.

Preferably, the storing means selectively stores the password or a combined password which is constituted by the password and an ancillary password. With this structure, a user needs not to determine the password for each use. If the apparatus is used by limited users using a common password, only the limited users can decrypt the data. Secrecy of data can be kept within the limited users.

Note that, the ancillary password may be a datum of the apparatus. In this case, attributes of the data can be easily known. A plurality of the ancillary passwords may be stored in the storing means so as to further improve the secrecy of data.

Further, in the apparatus, the storing means may previously store hush function data, the control means may convert the password into a hush value on the basis of the hush function data, and the decrypting means may decrypt the encrypted data of the system area on the basis of the hush value. With this structure, variations of secrecy, which are caused by passwords determined by users, can be uniform. Further, length of encryption keys and decryption keys can be fixed, so processing the data can be easily performed.

Another data processing apparatus comprises:

means for storing data and hush function data;

means for writing data in a recording medium;

means for encrypting data on the basis of a password; and

means for controlling the storing means, the writing means and the encrypting means,

wherein the control means stores main data in the storing means,

stores data of a system area of the recording medium, which are used so as to recognize the recording medium, in the storing means,

converts the password or a combined password, which is constituted by the password and an ancillary password, into a hush value on the basis of the hush function data,

encrypts at least a part of the data of the system area,

writes the encrypted data of the system area, by the writing means, in the recording medium,

writes the main data, by the writing means, in the recording medium, and

selects if the storing means stores the hush value or not.

Further, another data processing apparatus comprises:

means for storing hush function data;

means for reading data from a recording medium;

means for decrypting encrypted data on the basis of a password; and

means for controlling the storing means, the reading means and the decrypting means,

wherein the control means accesses the reading means to encrypted data of a system area of the recording medium, which are used so as to recognize the recording medium,

stores the encrypted data in the storing means,

converts the password or a combined password, which is constituted by the password and an ancillary password, into a hush value on the basis of the hush function data,

decrypts the encrypted data, and

selects if the storing means stores the hush value or not.

If the hush value is stored in the storing means, a user needs not to determine the password for each use. If the apparatus is used by limited users using a common password, only the limited users can easily access to data. Secrecy of the data can be kept within the limited users.

In the apparatus, the recording medium may be a removable medium. With this structure, the recording medium can be used in other apparatuses, whose environments are equal to that of the apparatus. Therefore, the encrypted data of the system area can be decrypted by other apparatuses. Further, only the limited users can easily access to the data by their apparatuses as common data.

### BRIEF DESCRIPTION OF THE DRAWINGS

Embodiments of the present invention will now be described by way of examples and with reference to the accompanying drawings, in which:

FIG. 1 is a block diagram of a data processing apparatus of a first embodiment of the present invention;

FIG. 2 is an explanation view of a structure of file system data;

FIG. 3 is a flowchart of processing data by the data processing apparatus of the first embodiment;

FIG. 4 is a block diagram of a data processing apparatus of a second embodiment of the present invention; and

FIG. 5 is a flowchart of processing data by the data processing apparatus of the second embodiment.

### DETAILED DESCRIPTION OF THE EMBODIMENTS

Preferred embodiments of the present invention will now be described in detail with reference to the accompanying drawings.

### First Embodiment

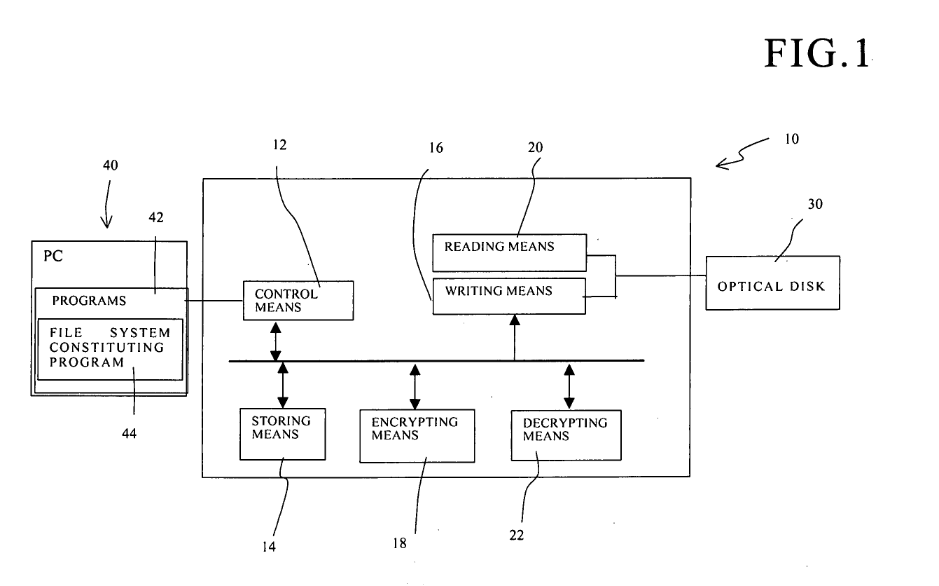

An outline of a data processing apparatus of a first embodiment will be explained with reference to FIG. 1. The data processing apparatus of the first embodiment is an optical disk player having an encrypting function.

The optical disk player 10 is connected to an external apparatus 40, e.g., a personal computer (PC). The personal computer 41 has application programs 42, which include a file system constituting program 44. The file system constituting program 44 constitutes file system data of a recording medium 30, e.g., a removal optical disk. The file system data are data of a system area of the optical disk 30 and used for recognizing the optical disk 30. The optical disk player 10 includes: means 14 for temporally storing ordinary data sent from the PC 40, e.g., RAM; means 16 for writing data stored in the storing means 14 in the optical disk 30; means 18 for encrypting the file system data on the basis of a password inputted by the program 42; means 20 for reading encrypted data from the optical disk 30; means 22 for decrypting encrypted file system data on the basis of a password inputted by the program 42; and means 12 for controlling the storing means 14, the writing means 16, the encrypting means 18, the reading means 20 and the decrypting means 22.

In the present embodiment, the encrypting means 18 and the decrypting means 22 are separated as independent means or units, but the control means 12 including a CPU, etc. may act as the encrypting means 18 and the decrypting means 22.

Further, one optical pick-up may act as the writing means 16 and the reading means 20.

The application programs 42 are installed in memories (not shown) of the PC 40. A user starts the application programs 42 of the PC 40 and inputs commands to the control means 12 so as to control the optical disk player 10.

When the user sends a command, via the application program 42, to the optical disk player 10 so as to write data in the optical disk 30, the control means 12 temporarily stores the data in the storing means 14 of the optical disk player 10, then the writing means 16 writes the data, which have been stored in the storing means 14, in the optical disk 30. Further, the data of the system area of the optical disk 30 are encrypted so as to prohibit access to the optical disk 30.

As described above, the application programs 42 include the file system constituting program 44, which constitutes the data of the system area of the optical disk 30.

The file system data are control data for managing data files to be written in the optical disk 30.

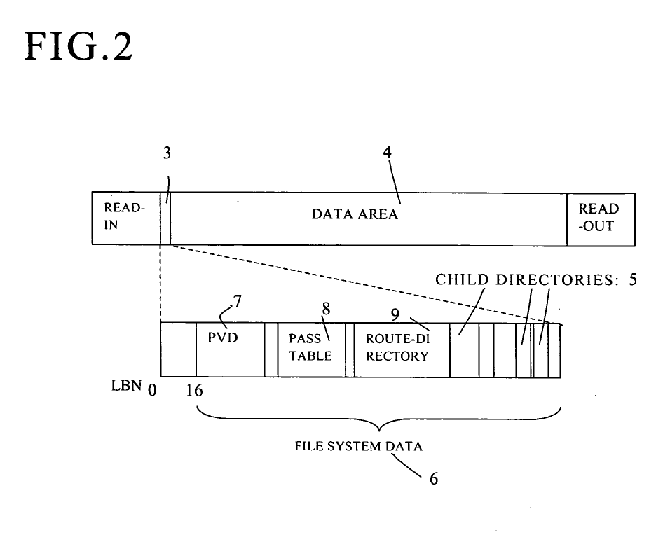

The file system data will be explained with reference to FIG. 2. FIG. 2 is an explanation view of a structure of the file system data 6 in a system area 3.

According to ISO 9660, the system area 3 is located ahead of a data area 4. Logical blocks, each of which has a size of 2 kB, are serially arranged from a head of the system area 3. Logical block numbers (LBN) are assigned to the logical blocks. The file system data 6 are written from the logical block LBN 16.

The file system data 6 includes a primary volume descriptor (PVD) 7, a pass table 8 and a route directory 9, which includes child directories 5.

Identification of file format, sizes of volumes, a size of the pass table 8, addresses, etc. are written in the PVD 7.

Addresses of the child directories 5, which have layered structures, are written in the pass table 8. By reading the pass table 8, the addresses of the child directories 5, etc. can be known.

Note that, the structure of the file system data 6 is not limited to the structure based on ISO 9660. File system data based on other standards are located in other places.

In the present embodiment, the file system constituting program 44 forms data to be written into the layered structure before the writing means 16 writes the data in the optical disk 30, makes the file system data 6 on the basis of a starting address and length of each file and writes them in the data area 4.

Note that, the file system data 6 of the system area 3 are encrypted on a password, which has been determined by a user and inputted via the application program 42, and written in the optical disk 30. Details will be described later.

By encrypting the file system data 6 and writing them in the optical disk 30, the format and the starting address of each file, etc. of the data written in the optical disk 30 cannot be read by another optical disk player. Therefore, contents of the optical disk 30 cannot be known by encrypting the file system data 6 only. Namely, even if the main data written in the data are 4 are not encrypted, the optical disk 30 has enough secrecy. Further, time for encrypting data can be shortened.

The encrypting means 18 encrypts the file system data 6 on the basis of the password, which have been determined by user and inputted via the application program 42. An ancillary password or passwords may be further used. By using the ancillary password or passwords, the secrecy of the encryption can be improved.

The ancillary passwords are, for example, data of the optical disk player 10, e.g., a serial number of the optical disk player 10, a type of the optical disk player 10, a name of a group whose members are permitted to access to the data. The ancillary passwords have been previously stored in the storing means 14. Further, some ancillary passwords may be determined before shipment; some ancillary passwords may be determined by users.

The password, which has been determined by the user, and the ancillary password are combined, and the combined password acts as an encryption key. Therefore, even if a third person gets the password, he or she cannot decrypt the encrypted data without the ancillary password. Note that, the encryption key may be constituted by the password only.

Further, the encryption key may be substantially constituted by the ancillary password. In this case, the combined password may be constituted by the password including no characters (blanks or spaces only) and the ancillary password.

The encrypting means 18 encrypts the file system data 6 on the basis of a prescribed encrypting algorithm, which is selected form many known cryptosystems. In the present embodiment, the password determined by the user or the combined password, which includes the password determined by the user and the ancillary password, is used as the encryption key. For example, the key encryption may be used as a key of a private key cryptosystem, e.g., DES. The cryptosystem is not limited.

Note that, the decrypting means 22 decrypts data on the basis of the algorithm corresponding to the algorithm of the encrypting means 18.

When the file system data 6 are encrypted, at least a part of the data 6 should be encrypted. For example, if the PVD 7 are encrypted, the file format of the optical disk 30 cannot be known, so that the secrecy of the main data can be kept.

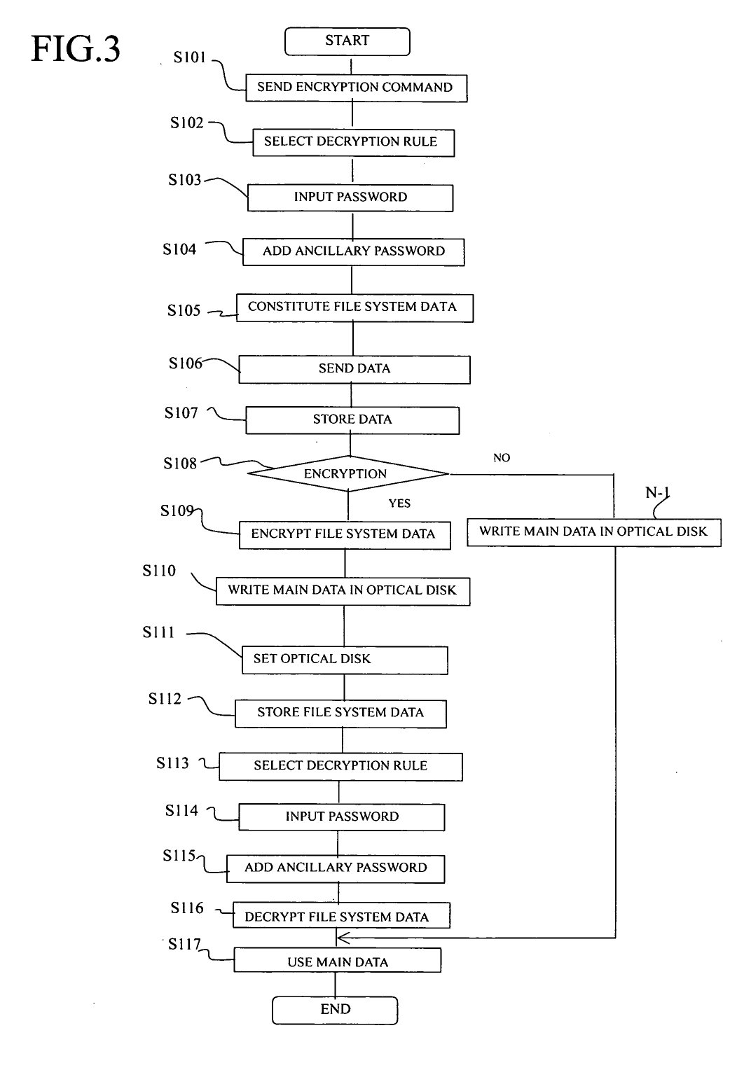

Next, the method of processing data of the first embodiment will be explained. FIG. 3 is a flowchart of processing data by the optical disk player 10.

When the user selects to encrypt data, a command of executing the encryption is inputted by the PC 40. The application program 42 sends the command to the optical disk player 10 (Step S101). The user selects a decryption rule (Step S102) and inputs the password for encrypting the file system data 6 (Step S103).

Upon receiving the password, the control means 12 adds the ancillary password for distinguishing a decryption rule to the password (Step S104). Then, the file system constituting program 44 constitutes file system data of the optical disk 30 (Step S105).

Data including the file system data and main data are sent from the PC 40 to the optical disk player 10 via the application programs 42 (Step S106). When the optical disk player 10 receives the data, the control means 12 temporarily stores the data in the storing means which includes main data (Step S107).

Then, the user selects if the encryption of the optical disk 30 is executed or not (Step S108). If user selects “No”, the main data are written in the optical disk 30 without executing the encryption (Step N-1). The data can be used as ordinary data without decryption (Step S117).

On the other hand, if user selects “Yes” in the Step S108, the control means 12 encrypts a part of the file system data with a encryption key, which is combination of the password and the ancillary password (Step S109). The encrypted file system data and the main data are written in the optical disk 30 by the writing means 16 (Step S110).

To use the main data written in the optical disk 30, the encrypted file system data written in the optical disk 30 must be decrypted. The decryption process will be explained.

When the encrypted data are decrypted, the user sets the optical disk 30 in the optical disk player 10 (Step S111). Then, the control means 12 reads the encrypted file system data written in the optical disk 30 by the reading means 20 and temporarily stored them in the storing means 14 (Step S112). The user selects the decryption rule, which must correspond to that of the encryption, via the application program 42 (Step S113). After inputting the decryption rule, the user inputs the password, which has been determined to encrypt the ordinary data, via the application program 42 (Step S114). Then, the control means 12 add the ancillary password to the password (Step S115).

The control means 12 reads the encrypted file system data of the optical disk 30, by the reading means 20, from the storing means 14 and sends them to the data decrypting means 22. The decrypting means 22 decrypts the encrypted data on the basis of the combined password, which includes the password inputted by the user and the ancillary password relating to the decryption rule, or the encryption key (Step S116). If the password is correct, the encrypted file system data are converted into ordinary file system data, so that the control means 12 can know a data structure of the optical disk 30. Therefore, the control means 12 can access to the main data written in the optical disk 30, so that the main data can be used as ordinary data (Step S117).

On the other hand, if a wrong password is inputted, a wrong combined password is formed, so that the encrypted file system data cannot be correctly converted. Therefore, the data structure of the optical disk 30 cannot be known. Namely, the optical disk 30 is not recognized.

### (Second Embodiment)

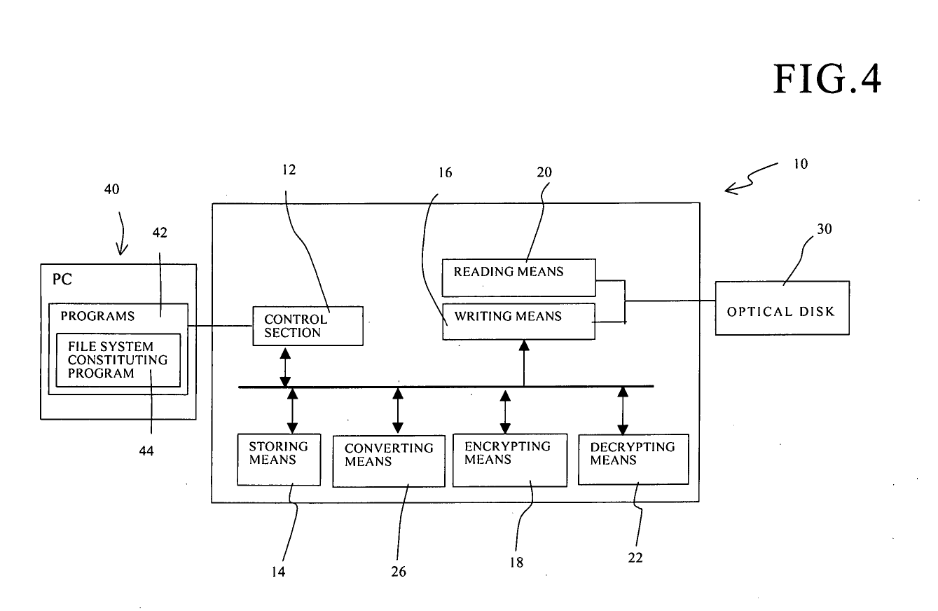

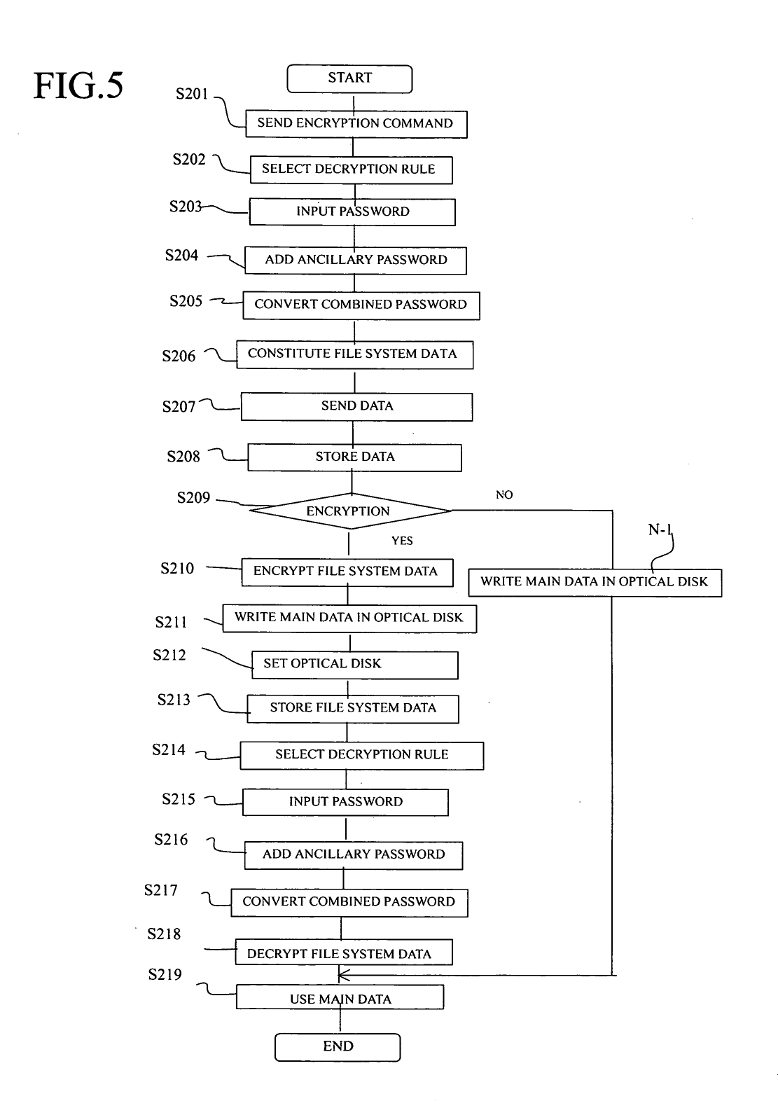

The data processing apparatus of a second embodiment will be explained with reference to FIGS. 4 and 5.

In the first embodiment, the encryption and the decryption are performed on the basis of the combined password or the encryption key, which is constituted by the password determined by the user and the ancillary password relating to the selected decryption rule.

On the other hand, in the second embodiment, the optical disk player 10 (the data processing apparatus) further includes a password converting means 26. When the file system data are encrypted and the encrypted file system data are decrypted, the password or the combined password (the character string) is converted to a numeric value or values on the basis of a prescribed function. Namely, the numeric value or values are used as a key for encrypting and decrypting the file system data.

FIG. 4 shows a structure of the optical disk player 10 of the second embodiment. The elements described in the first embodiment are assigned the same symbols, and explanation will be omitted.

The password converting means 26 converts the password or the combined password, which is a character string including the password and the ancillary password, to numeric values. There many processes to convert a character string to numeric values. In the present embodiment, the character string is converted by hush function. The hush function is a one-way function, so it is substantially impossible to know the original character string. By using the hush function, the secrecy of data can be improved.

The action of the optical disk player 10 of the second embodiment will be explained with reference to a flowchart of FIG. 5.

When the user selects to encrypt data, a command of executing the encryption is inputted by the PC 40. The application program 42 sends the command to the optical disk player 10 (Step S201). The user selects a decryption rule (Step S202) and inputs the password for encrypting the file system data 6 (Step S203).

Upon receiving the password, the control means 12 adds the ancillary password for distinguishing a decryption rule to the password (Step S204).

Next, the password converting means 26 converts the combined password, which includes the password and the ancillary password, into a hush value (Step S205). Then, the file system constituting program 44 constitutes file system data of the optical disk 30 (Step S206).

Data including the file system data and main data are sent from the PC 40 to the optical disk player 10 via the application programs 42 (Step S207). When the optical disk player 10 receives the data, the control means 12 temporarily stores the data in the storing means 14 which includes main data (Step S208).

Then, the user selects if the encryption of the optical disk 30 is executed or not (Step S209). If user selects “No”, the main data are written in the optical disk 30 without executing the encryption (Step N-1). The data can be used as ordinary data without decryption (Step S219).

On the other hand, if user selects “Yes” in the Step S209, the control means 12 encrypts the file system data with a encryption key, which is the hush value of the combined password (Step S210). The encrypted file system data and the main data are written in the optical disk 30 by the writing means 16 (Step S211).

To use the main data written in the optical disk 30, the encrypted file system data written in the optical disk 30 must be decrypted. The decryption process will be explained.

When the encrypted data are decrypted, the user sets the optical disk 30 in the optical disk player 10 (Step S212). Then, the control means 12 reads the encrypted file system data written in the optical disk 30 by the reading means 20 and temporarily stored them in the storing means 14 (Step S213). The user selects the decryption rule, which must correspond to that of the encryption, via the application program 42 (Step S214). After inputting the decryption rule, the user inputs the password, which has been determined to encrypt the ordinary data, via the application program 42 (Step S215). Then, the control means 12 add the ancillary password to the password (Step S216).

Then, the password converting means 26 converts the combined password into a hush value (Step S217). The decrypting means 22 decrypts the encrypted data on the basis of the hush value as the encryption key (Step S218).

If the password is correct, the hush values or keys correspond, so that the encrypted file system data can be converted into ordinary file system data. Therefore, the control means 12 can know a data structure of the optical disk 30, so that the control means 12 can access to the main data written in the optical disk 30, and the main data can be used as ordinary data (Step S219). If user inputs a wrong password and the ancillary password, the control means 12 shows “ERROR” on a display screen (not shown) of the PC 40.

If the hush values are once stored in the second memory 24, the password and the decryption rule need not be inputted for each encryption and decryption. In the case that the optical disk player 10 can be used by limited users only, the users can easily and efficiently encrypt and/or decrypt data without inputting the password and the decryption rule.

The present invention is not limited to the first and the second embodiments.

For example, data of a table of contents (TOC), a program memory area (PMA), etc. in the system area 3 may be used as the data of the system area 3 instead of the file system data.

In the above described embodiments, the encryption and the decryption are performed in the data processing apparatus 10. But data may be encrypted by an external apparatus and decrypted in the data processing apparatus 10. In this case, the decryption algorithm of the data decrypting means 22 must be corresponded to an encrypting algorithm of an encrypting program of the external apparatus. Namely, the data recording and reading apparatus 10 can decrypt data without installing the encrypting program in the PC 40.

In the above described embodiments, the data are encrypted and decrypted by a private key cryptosystem. But a public key cryptosystem may be employed.

Further, the ancillary password may be an optional character string instead of the data of the data processing apparatus 10. The ancillary password may be determined by user and stored in the storing means 14.

The means for inputting the password, etc. may be provided to a body proper of the data processing apparatus 10 instead of the PC 40.

Further, the recording medium 30 may be a removal medium or a fixed medium, and various types of media, e.g., optical disks, magnetic disks, optical-magnetic disks, can be used as the recording medium.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. A method of writing data with a data processing apparatus comprising:
means for storing data;
means for writing data in a recording medium; and
means for encrypting data on the basis of a password,
said method comprising the steps of:
storing data of a system area of the recording medium, which are used by said writing means so as to recognize the recording medium, in said storing means;
encrypting at least a part of the data of the system area, by said encrypting means, on the basis of the password;
storing main data in said storing means;
writing the encrypted data of the system area, by said writing means, in the recording medium; and
writing the main data, by said writing means, in the recording medium.

2. A method of reading data with a data processing apparatus comprising:
means for storing data;
means for reading data from a recording medium; and
means for decrypting encrypted data on the basis of a password, said method comprising the steps of:
accessing said reading means to data of a system area of the recording medium, which are used so as to recognize the recording medium;
storing the data of the system area, which have been encrypted, in said storing means; and
decrypting the encrypted data of the system area, by said decrypting means, on the basis of the password.

3. A data processing apparatus, comprising:
means for storing data;
means for writing data in a recording medium;
means for encrypting data on the basis of a password; and
means for controlling said storing means, said writing means and said encrypting means,
wherein said control means stores data of a system area of the recording medium, which are used by said writing means so as to recognize the recording medium, in said storing means,
encrypts at least a part of the data of the system area, by said encrypting means, on the basis of the password,
stores main data in said storing means,
writes the encrypted data of the system area, by said writing means, in the recording medium, and
writes the main data, by said writing means, in the recording medium.

4. A data processing apparatus, comprising:
means for storing data;
means for reading data from a recording medium;
means for decrypting encrypted data on the basis of a password; and
means for controlling said storing means, said reading means and said decrypting means,
wherein said control means accesses said reading means to data of a system area of the recording medium, which are used so as to recognize the recording medium;
stores the data of the system area, which have been encrypted, in said storing means; and
decrypts the encrypted data of the system area, by said decrypting means, on the basis of the password.

5. The data processing apparatus according to claim 3,
wherein an ancillary password is previously stored in said storing means,
said control means adds the ancillary password to the password, and
said encrypting means encrypts the data of the system area on the basis of the combined password.

6. The data processing apparatus according to claim 4,
wherein an ancillary password is previously stored in said storing means,
said control means adds the ancillary password to the password, and
said encrypting means encrypts the data of the system area on the basis of the combined password.

7. The data processing apparatus according to claim 3,
wherein said storing means selectively stores the password or a combined password which is constituted by the password and an ancillary password.

8. The data processing apparatus according to claim 4,
wherein said storing means selectively stores the password or a combined password which is constituted by the password and an ancillary password.

9. The data processing apparatus according to claim 3,
wherein said storing means previously stores hush function data,
said control means converts the password into a hush value on the basis of the hush function data, and
said encrypting means encrypts the data of the system area on the basis of the hush value.

10. The data processing apparatus according to claim 4,
wherein said storing means previously stores hush function data,
said control means converts the password into a hush value on the basis of the hush function data, and
said decrypting means decrypts the encrypted data of the system area on the basis of the hush value.

11. A data processing apparatus, comprising:
means for storing data and hush function data;
means for writing data in a recording medium;
means for encrypting data on the basis of a password or a combined password, which is constituted by the password and an ancillary password, and
means for controlling said storing means, said writing means and said encrypting means,
wherein said control means stores main data in said storing means,
stores data of a system area of the recording medium, which are used so as to recognize the recording medium, in said storing means,
converts the password or a combined password, which is constituted by the password and an ancillary password, into a hush value on the basis of the hush function data,
encrypts at least a part of the data of the system area,
writes the encrypted data of the system area, by said writing means, in the recording medium,
writes the main data, by said writing means, in the recording medium, and
selects if the storing means stores the hush value or not.

12. A data processing apparatus, comprising:
means for storing hush function data;
means for reading data from a recording medium;
means for decrypting encrypted data on the basis of a password or a combined password, which is constituted by the password and an ancillary password, and
means for controlling said storing means, said reading means and said decrypting means,
wherein said control means accesses said reading means to encrypted data of a system area of the recording medium, which are used so as to recognize the recording medium,
stores the encrypted data in said storing means,
converts the password or a combined password, which is constituted by the password and an ancillary password, into a hush value on the basis of the hush function data,
decrypts the encrypted data, and
selects if the storing means stores the hush value or not.
